(19) United States
(12) Patent Application Publication
(10) Pub. No.: US 2004/0024559 A1
(43) Pub. Date: Feb. 5, 2004

(54) Method, system and computer product for building calibration lookup tables from sparse data

(76) Inventors: John Harry Down, Lanesborough, MA (US); Harry Kirk Mathews JR., Clifton Park, NY (US)

Correspondence Address: CANTOR COLBURN, LLP, 55 GRIFFIN ROAD SOUTH, BLOOMFIELD, CT, 06002

(21) Appl. No.: 10/064,639

(22) Filed: Aug. 1, 2002

(51) Int. Cl. G01D 18/00

(52) U.S. Cl. 702/127

(57) ABSTRACT

A method for building calibration lookup tables from sparse data. The method comprises initializing the lookup table including initializing a Kalman filter corresponding to the lookup table, where the Kalman filter includes state estimates that correspond to table element values in the lookup table. The method further comprises receiving sensor measurement data and applying the sensor measurement data to the lookup table. Applying the sensor measurement data to the lookup table includes updating the Kalman filter in response to the sensor measurement data. The method further comprises receiving a constraint on the table element values and receiving an output request. A duplicate copy of the Kalman filter is stored in response to receiving the output request. The constraint is applied to the lookup table in response to receiving the output request and to the storing. Applying the constraint includes updating the Kalman filter in response to the constraint. The method further includes outputting a lookup table element in response to the applying the constraint and the output request. The Kalman filter is replaced with the duplicate copy of the Kalman filter in response to the outputting.

### BACKGROUND OF THE INVENTION

The present disclosure relates generally to a method for building calibration lookup tables from sparse data and in particular, to a method of imposing constraints on the estimation of a lookup table.

Computer software can be used to perform a variety of diagnostics. For example, diagnostics on a gas turbine engine can be performed using a model based algorithm using data collected from attached sensors. Since the parameters of the model may be unknown, or may change, they can be estimated from sensor data measurements that are taken when the gas turbine engine is operating fault free. Typically, because no pre-determined test plan is executed, the data collected for the model parameter estimation is sparse data and includes sets of data at the same operating points. For example, effective area measurements of the flowpath (the model parameter) can be captured at specific pressure ratio and delta temperature points from sensor data when the gas turbine engine is operating fault free. The relationship among these three variables could then be determined in the form of a lookup table. An engine diagnostics software application could use this lookup table to dynamically adjust the model parameter value(s) when determining if there is a fault in the gas turbine engine during operation. Ideally, the lookup table contains values in each of the table positions for use by the diagnostics software. Interpolation around the sparse data can be used to fill in the lookup table.

Systems using sensors or employing model-based techniques (e.g., control, estimation and fault detection) often require well-calibrated sensors and/or models. Lookup tables are commonly used to capture the calibration curves. The type of interpolation used in the tables is application specific but linear is the most common. Often, the calibration changes with time or the calibration data is collected a little at a time and the lookup tables may need to be recreated to reflect the calibration changes and the calibration data. Ideally, the lookup table is fit to a well-conditioned set of data. If the data set is not well-conditioned then the size of the lookup table (i.e., order) is reduced until it is. This process can be automated by evaluating the goodness of fit for a number of different orders and then choosing the lowest good fitting order. One disadvantage to this process of evaluating the goodness of fit for a number of different orders is the computational load of fitting several different lookup tables to the data. Also, when the order changes with new data, the old fit is not easily translated to the new size, making recursive algorithms computationally expensive.

The Kalman filter is a set of mathematical equations that can be used to estimate the state of a time controlled process. The Kalman filter uses a mathematical model and known inputs to predict state values, or outputs, even when the exact nature of the modeled system is not known and the measurements includes noise. The typical Kalman filter includes two types of mathematical equations: those that predict state values and those that correct the predicted state values. The equations that predict state values project forward in time the current state and covariance estimates in order to create a state and covariance estimate for the next point in time. The equations that correct the predicted state values are measurement update equations that provide feedback to the Kalman filter to improve the estimates for each state and update the associated covariance. The measurement update equations can take into account an unknown amount of noise, but known statistics, associated with the measurement and the Kalman filter can be utilized to determine how much weight to give to measurements and estimates.

### SUMMARY OF THE INVENTION

One aspect of the invention is a method for building calibration lookup tables from sparse data. The method comprises initializing the lookup table including initializing a Kalman filter corresponding to the lookup table, where the Kalman filter includes state estimates that correspond to table element values in the lookup table. The method further comprises receiving sensor measurement data and applying the sensor measurement data to the lookup table. Applying the sensor measurement data to the lookup table includes updating the Kalman filter in response to the sensor measurement data. The method further comprises receiving a constraint on the table element values and receiving an output request. A duplicate copy of the Kalman filter is stored in response to receiving the output request. The constraint is applied to the lookup table in response to receiving the output request and to the storing. Applying the constraint includes updating the Kalman filter in response to the constraint. The method further includes outputting a lookup table element in response to the applying the constraint and the output request. The Kalman filter is replaced with the duplicate copy of the Kalman filter in response to the outputting.

One aspect of the invention is a method for building calibration lookup tables from sparse data. The method comprises initializing the lookup table including initializing a Kalman filter corresponding to the lookup table, where the Kalman filter includes state estimates that correspond to table element values in the lookup table. The method further comprises receiving a constraint on the table element values. The constraint is applied to the lookup table and includes updating the Kalman filter in response to the constraint. The method further comprises receiving sensor measurement data and applying the sensor measurement data to the lookup table. Applying the sensor measurement data to the lookup table includes updating the Kalman filter in response to the sensor measurement data.

Another aspect of the invention is a system for building calibration lookup tables from sparse data. The system comprises a sensor attached to a machine being diagnosed. The system further comprises a host system in communication with the sensor and the host system includes software to implement a method comprising initializing the lookup table including initializing a Kalman filter corresponding to the lookup table, where the Kalman filter includes state estimates that correspond to table element values in the lookup table. The method further comprises receiving sensor measurement data and applying the sensor measurement data to the lookup table. Applying the sensor measurement data to the lookup table includes updating the Kalman filter in response to the sensor measurement data. The method further comprises receiving a constraint on the table element values and receiving an output request. A duplicate copy of the Kalman filter is stored in response to receiving the output request. The constraint is applied to the lookup table in response to receiving the output request and to the storing. Applying the constraint includes updating the Kalman filter in response to the constraint. The method further includes outputting a lookup table element in response to the applying the constraint and the output request. The Kalman filter is replaced with the duplicate copy of the Kalman filter in response to the outputting.

Another aspect of the invention is a system for building calibration lookup tables from sparse data. The system comprises a sensor attached to a machine being diagnosed. The system further comprises a host system in communication with the sensor and the host system includes software to implement a method comprising initializing the lookup table including initializing a Kalman filter corresponding to the lookup table, where the Kalman filter includes state estimates that correspond to table element values in the lookup table. The method further comprises receiving a constraint on the table element values. The constraint is applied to the lookup table and includes updating the Kalman filter in response to the constraint. The method further comprises receiving sensor measurement data and applying the sensor measurement data to the lookup table. Applying the sensor measurement data to the lookup table includes updating the Kalman filter in response to the sensor measurement data.

A further aspect of the invention is a computer program product for building calibration lookup tables from sparse data. The computer program product comprises a storage medium readable by a processing circuit and storing instructions for execution by the processing circuit for performing a method comprising initializing the lookup table including initializing a Kalman filter corresponding to the lookup table, where the Kalman filter includes state estimates that correspond to table element values in the lookup table. The method further comprises receiving sensor measurement data and applying the sensor measurement data to the lookup table. Applying the sensor measurement data to the lookup table includes updating the Kalman filter in response to the sensor measurement data. The method further comprises receiving a constraint on the table element values and receiving an output request. A duplicate copy of the Kalman filter is stored in response to receiving the output request. The constraint is applied to the lookup table in response to receiving the output request and to the storing. Applying the constraint includes updating the Kalman filter in response to the constraint. The method further includes outputting a lookup table element in response to the applying the constraint and the output request. The Kalman filter is replaced with the duplicate copy of the Kalman filter in response to the outputting.

A further aspect of the invention is a computer program product for building calibration lookup tables from sparse data. The computer program product comprises a storage medium readable by a processing circuit and storing instructions for execution by the processing circuit for performing a method comprising initializing the lookup table including initializing a Kalman filter corresponding to the lookup table, where the Kalman filter includes state estimates that correspond to table element values in the lookup table. The method further comprises receiving a constraint on the table element values. The constraint is applied to the lookup table and includes updating the Kalman filter in response to the constraint. The method further comprises receiving sensor measurement data and applying the sensor measurement data to the lookup table. Applying the sensor measurement data to the lookup table includes updating the Kalman filter in response to the sensor measurement data.

Further aspects of the invention are disclosed herein. The above discussed and other features and advantages of the present invention will be appreciated and understood by those skilled in the art from the following detailed description and drawings.

### BRIEF DESCRIPTION OF THE DRAWINGS

Referring to the exemplary drawings wherein like elements are numbered alike in the several FIGURES:

FIG. 1 is a block diagram of an exemplary system for building calibration lookup tables;

FIG. 2 is a block diagram of an exemplary embodiment of the present invention for building calibration lookup tables using a Kalman filter;

FIG. 3 is a block diagram of an alternate exemplary embodiment of the present invention for building calibration lookup tables using a Kalman filter;

FIG. 4 is an exemplary embodiment of a one dimensional lookup table created without imposing constraints through pseudo-measurements;

FIG. 5 is an exemplary embodiment of a one dimensional lookup table created by imposing constraints though pseudo-measurements;

FIG. 6 is an exemplary embodiment of a two dimensional lookup table created without imposing constraints through pseudo-measurements; and

FIG. 7 is an exemplary embodiment of a two dimensional lookup table created by imposing constraints through pseudo-measurements.

### DETAILED DESCRIPTION

One embodiment of the present invention is a method for automatically building calibration lookup tables from sparse data. A Kalman filter is used to fit the elements of a lookup table to the available data. Elements of the lookup table are modeled as the states, the sensor derived data are the measurements and the table output is the measurement model in the Kalman filter framework. Pseudo-measurements, measurements not coming from an actual sensor, are used to incorporate constraints (e.g., level, slope and curvature) into the Kalman filter. The resulting fully populated lookup table can be used as input to error detection software.

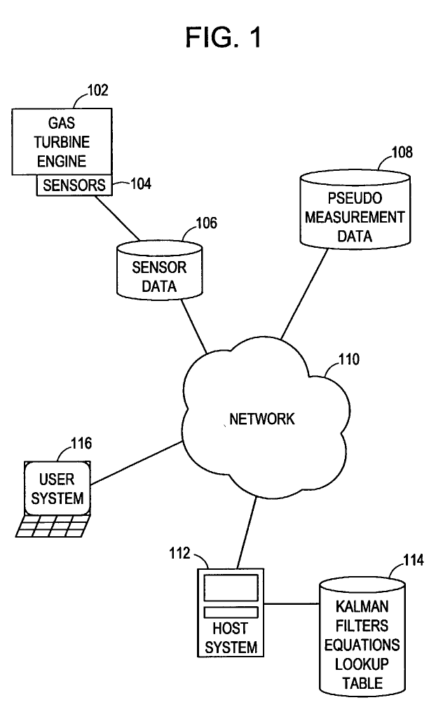

FIG. 1 is a block diagram of an exemplary system for building calibration lookup tables. FIG. 1 includes a gas turbine engine 102 that has one or more sensors 104 attached for data collection. In an exemplary embodiment, the sensors 104 are attached to the fluid handling system of a gas turbine engine 102 and the sensor 104 data is used to calculate pressure ratio, delta temperature and effective area of the flowpath. Alternate embodiments can be implemented for any system (e.g., injected volume of fuel versus injection duration, or pump map, in a diesel engine) being measured using sensors or employing model-based techniques (e.g. control, estimation and fault detection). In the exemplary embodiment depicted in FIG. 1, the data collected by the sensors 104, the sensor data, is stored in a sensor database 106 and the sensors 104 are directly attached to the sensor database 106. Alternatively, the sensors 104 could be attached to the sensor database 106 via the network 110. In an alternate exemplary embodiment, the sensor data is not stored in a database and is transmitted directly to the host system 112 as it is being gathered by the sensors 104.

The system of FIG. 1 includes a user system 116 through which a user can invoke an application program to build a calibration lookup table. Additionally, the application program to build calibration lookup tables may be triggered by a system event (e.g., sensor data is updated, pseudo-measurement data is updated) or it may be scheduled to execute on a periodic basis. The user system 116 may be coupled to the host system 112 through a network 110 or it may be directly attached to the host system 112. Additionally, the user system 116 may be used to access the pseudo-measurement data stored in the pseudo-measurement database 108, the lookup table stored in the host database 114, the Kalman filter equations stored in the host database 114 and the sensor data stored in the sensor database 106. In an exemplary embodiment, the host system 112 executes an application program to build calibration lookup tables. The user system 116 may be implemented using a personal computer or a host attached terminal. If the user system 116 is a personal computer, the processing and storage described herein may be shared by the user system 116 and the host system 112 in any manner known in the art (e.g., by providing an applet to the user system 116).

The network 110 may be any type of known network including a local area network (LAN), a wide area network (WAN), an intranet, or a global network (e.g., Internet). The user system 116, sensor database 106, pseudo-measurement database 108 and host database 114 may be coupled to the host system 112 through multiple networks (e.g., intranet and Internet) so that it is not necessary for all user systems 116 and databases to be coupled to the host system 112 through the same network. The user system 116, databases (sensor database 106, pseudo-measurement database 108 and host database 114) and the host system 112 may be connected to the network 110 in a wireless fashion and the network 110 may be a wireless network. In an exemplary embodiment, the user system 116 executes a user interface application (e.g., web browser) to contact the host system 112 through the network 110.

The host system 112 may be implemented using a server operating in response to a computer program stored in a storage medium accessible by the server. In an exemplary embodiment, the computer program is stored on the host database 114. The host system 112 may operate as a network server (often referred to as a web server) to communicate with the user system 116, sensor database 106, pseudo-measurement database 108 and host database 114. The host system 112 can handle sending and receiving information to and from the user system 116, sensor database 106, pseudo-measurement database 108 and host database 114 and can perform associated tasks. The host system 112 may also include a firewall to prevent unauthorized access to the host system 112 and enforce any limitations on authorized access. For example, an administrator may have access to the entire system and have authority to modify portions of the system. The firewall may be implemented using conventional hardware and/or software as is known in the art.

The host system 112 also operates as an application server and executes one or more computer programs to build a calibration lookup table. In an exemplary embodiment, the application to build a calibration lookup table can include accessing sensor data and pseudo-measurement data and outputting a lookup table in the host database 114. In addition, constraints can be added and updated in the pseudo-measurement database 108 using the application to build a calibration lookup table. Processing may be shared by the user system 116 and the host system 112 by providing an application (e.g., java applet) to the user system 116. Alternatively, the user system 116 can include a stand-alone software application for performing a portion of the processing described herein. It is understood that separate servers may be used to implement the network server functions and the applications server functions. Alternatively, the network server, firewall and the applications server can be implemented by a single server executing computer programs to perform the requisite functions.

The sensor database 106, pseudo-measurement database 108 and host database 114 can be implemented using a variety of devices for storing electronic information such as a file transfer protocol (FTP) server. It is understood that these devices may be implemented using memory contained in the host system 112 or user system 116 or that they may be on separate physical devices as depicted in FIG. 1. The sensor database 106 includes sensor data that has been collected by the sensors 104. The pseudo-measurement database 108 includes pseudo-measurement data such as constraint data that will be used to fill in the lookup table. The host database 114 includes Kalman filter data (e.g., predictor equations and measurement update equations) and lookup table data. The lookup table includes elements that correspond to a state in the Kalman filter. In an exemplary embodiment, the Kalman filter state data, or state estimates, and the lookup table data element values utilize shared storage, and therefore updates to the Kalman filter states are updates to the lookup table elements. In another exemplary embodiment, the Kalman filter state data and lookup table are stored in two different physical locations with updates being made to the Kalman filter state estimates and lookup table data element values in close time proximity. The host system 112 may also operate as a database server and coordinate access to application data including data stored in the sensor database 106, pseudo-measurement database 108 and host database 114.

In an exemplary embodiment, the host system 112 includes memory for storing the sensor database 106, the pseudo-measurement database 108 and the host database 114. The application for building calibration tables is executed in response to changes being made to the sensor database 106 and pseudo-measurement database 108. Additionally, the sensors 104 and host system 112 are geographically located in the same location and the host database 114 can be viewed by a user system 116 either by direct connection or through the network 110. In an alternate exemplary embodiment, the host system and the associated data is included in the system being measured (e.g., on the controller of the gas turbine engine 102).

In an exemplary embodiment of the present invention, a state space model is defined whose states are the elements of a lookup table of one or more dimensions. The outputs of the state space model are the lookup table results. In an exemplary embodiment, the dynamic model of all states are biases and therefore the elements are constant but unknown. The measurement model is the interpolation technique used by the table lookup algorithm. In an exemplary embodiment, a Kalman filter estimates the states (i.e., the table elements) by a weighted combination of the measurements (e.g., the data to which the table is being fit) and the measurement model (i.e. the interpolated table output). By imposing constraints on the Kalman filter through the use of pseudo-measurements, an embodiment of the invention can be used with small, sparse or ill conditioned data sets. The measurement model is augmented to include measurements of the constraints (e.g., slope and curvature) for which no actual measurement exists, commonly called pseudo measurements. These constraints can be applied at one or all positions in the table. If applied to all positions the values need not be identical. An example of a constraint is a slope constraint that specifies that the difference between two adjacent table element values can't be larger than a pre-selected value. The processing of pseudo-measurements can occur following initialization of the lookup table or just before each output of table element values from the lookup table.

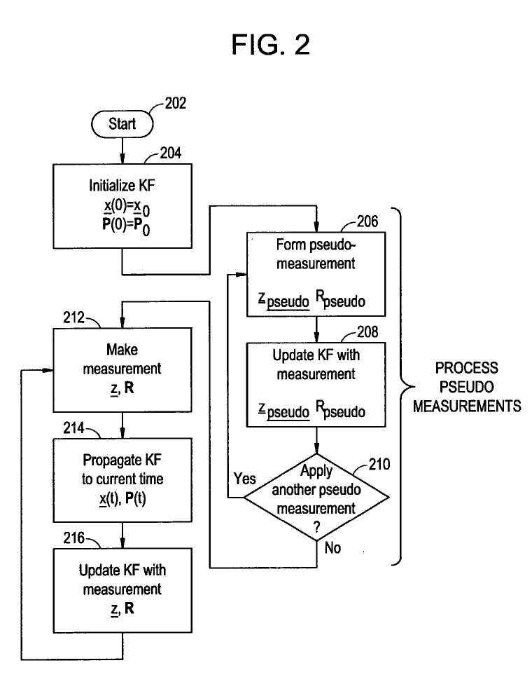

FIG. 2 is a block diagram of an exemplary embodiment of a process for using a Kalman filter to build a calibration table. In FIG. 2, the pseudo-measurements are processed once, following initialization of the Kalman filter. Using pseudo-measurements is a convenient way to initialize the Kalman filter in order to constrain the shape of the surface represented by the lookup table. The process starts at step 202. At step 204, the Kalman filter is initialized by entering initial state values, x₀, into the lookup table, x(0), and initial variance and cross-correlation of the error associated with the initial state values, P₀, into the co-variance matrix, P(0). In an exemplary embodiment, where the lookup table includes an effective area of the flow path at various delta temperature and pressure ratio values, step 204 would set the initial state estimates of effective area for each combination of delta temperature and pressure ratio table element in the lookup table. Step 204 would also initialize the co-variance matrix, P(0), to reflect the error statistics (e.g., variance and cross-correlation) associated with the initial estimates of effective area.

The next three steps in FIG. 2 (step 206, step 208 and step 210) process the pseudo-measurements associated with the lookup table. The Kalman filter processes the pseudo-measurements like any other measurement. At step 206, the pseudo-measurements is formed in order to give the Kalman filter a measurement value and associated error covariance. In an alternate exemplary embodiment, the pseudo-measurement is retrieved from storage (e.g., the pseudo-measurement database 108). The value of the pseudo-measurement, z_{pseudo}, is an a-priori estimate of the constraint and the measurement noise matrix, R_{pseudo}, is the associated uncertainty in the constraint (e.g., the covariance matrix). In an exemplary embodiment, these two values are statistical equality constraints rather than absolute equality or inequality constraints. For example, the pseudo-measurement, z_{pseudo}, may instruct the Kalman filter that the slope based on adjacent elements in the lookup table must be on average z_{pseudo}, but can differ from it by the variance specified in a co-variance matrix, R_{pseudo}. Other constraints can be imposed by the pseudo-measurement including curvature, level and any other constraint that can be represented as a function of the states. At step 208, the Kalman filter, and therefore the table element values in the lookup table, is updated with the pseudo-measurement in order to improve the estimates. In addition, the co-variance matrix, P, that tracks the error in the lookup table is also updated based on the pseudo-measurement. A check is made at step 210 to determine if another pseudo-measurement should be applied. If another pseudo-measurement should be applied then steps 206 through 210 are repeated. Otherwise, step 212 is performed. In an alternate embodiment, results of applying the pseudo-measurements can be pre-computed and included as part of initialization in step 204 and steps 206, 208 and 210 can be eliminated.

At step 212 through step 216 in FIG. 2, actual measurement data that has been generated by a sensor 104 is processed by the Kalman filter and therefore table element values are updated in the lookup table. At step 212, the measurement is performed by running the engine 102 and by having the sensors 104 collect data. The sensor data is sent to the host system 112 from the sensors 104 or retrieved from the sensors 104 by the host system 112. Alternatively, the sensor data could be stored in a storage device (e.g., sensor database 106) and retrieved from the storage device by the host system 112 or sent to the host system 112 from the storage device. The sensor data is represented in FIG. 2 as a measurement vector, z, along with an associated co-variance matrix, R. In an exemplary embodiment, the covariance matrix, R, is not sensor data and must be known before or computed at the time of the measurement. In an exemplary embodiment, where the lookup table elements include an effective area of the flow path at various delta temperature and pressure ratio values, the measurement vector would include a sensor measurement for each of these three variables. The co-variance matrix would include the variance and cross-correlation of the error associated with the sensor measurements. An exemplary embodiment includes three measurements or variables but alternate embodiments can include any number of measurements. At step 214, the Kalman filter is propagated to the current time. In an exemplary embodiment of the present invention, the lookup table and the associated co-variance matrix do not change based on time and therefore this step would not be performed. In another exemplary embodiment the table lookup elements are known to drift slowly in time and the dynamic model must allow for this drift. One common approach is to model the states, or table elements, as a random walk, in which case the propagation of the states would remain the same but the covariance matrix would have a constant matrix, Q, added to, it. The Kalman filter is updated with the measurement data from the sensors at step 216 in order to provide better estimates. In an exemplary embodiment, where the lookup table elements include an effective area of the flow path at various delta temperature and pressure ratio values, the values of effective area in the lookup table would be updated to reflect a better estimate of table element values. In addition, the covariance matrix, P, associated with the lookup table would be updated to reflect the incorporation of the actual measurement data by the Kalman filter. The loop from step 212 through step 216 continues for each measurement.

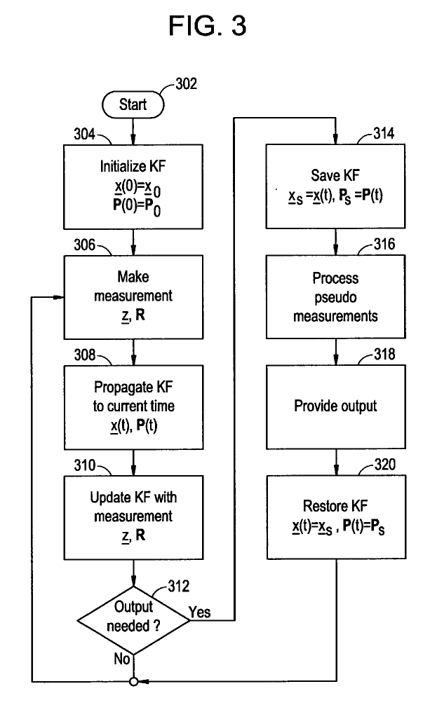

FIG. 3 is a block diagram of an alternate exemplary embodiment of the present invention for building calibration lookup tables. In FIG. 3, the Kalman filter processes the pseudo-measurements just before each output of table element values (i.e. just before each use of the lookup table). In an exemplary embodiment, the results of applying constraints to the lookup table through the use of pseudo-measurements are discarded and the constraints are reapplied each time an output is required. The process starts at step 302. At step 304, the Kalman filter is initialized by entering initial state values, x₀, into the lookup table, x(0), and the co-variance matrix, P(0). At step 306 through step 310, actual data that has been generated by a sensor 104 is processed by the Kalman filter and therefore table element values are updated in the lookup table. At step 308, the measurement is performed by running the engine 102 and by having the sensors 104 collect data. The sensor data is sent to the host system 112 from the sensors 104 or retrieved from the sensors 104 by the host system 112. Alternatively, the sensor data could be stored in a storage device (e.g., the sensor database) and retrieved by the host system 112 or sent to the host system 112 from the storage device. The sensor data is represented in FIG. 3 as a measurement vector, z, and its error statistics represented by a co-variance matrix, R. At step 308, the Kalman filter is propagated to the current time. In an exemplary embodiment of the present invention, the values of the lookup table and the associated co-variance matrices do not change over time and therefore this step would not be performed. In another exemplary embodiment the table lookup elements are know to drift slowly in time and the dynamic model must allow for this drift. One common approach is to model the states, or table elements, as a random walk in which case the propagation of the states would remain the same but the covariance matrix would have a constant matrix, Q, added to it. The Kalman filter is updated with the measurement data from the sensors 104 at step 310 in order to provide better estimates. At step 312, it is determined if output of table element values is needed. If output is not needed then the loop starting at step 306 is performed again. If output is required then step 314 is performed.

The next four steps in FIG. 3 (step 314, step 316, step 318 and step 320) process the constraints associated with the table element values in the lookup table and provide output of lookup table element values. In the exemplary embodiment depicted in FIG. 3, when output is requested the table element values in the lookup table are smoothed out based on the constraints and then the result is sent to the output requestor. Once the table element values are output, the state of the Kalman filter and lookup table from prior to applying the constraints is restored. At step 314, a duplicate copy of the current state of the Kalman filter x(t), is saved in x_{S}, and a duplicate copy of the current state of the associated co-variance matrix, P(t), is saved in P_{S}. At step 316, the pseudo-measurements are processed. This process is the same process described in reference to FIG. 2 at steps 206 through 210. The lookup table output including table element values is provided at step 318. At step 320, the original Kalman filter values from prior to step 316 are restored and the loop beginning at step 306 is performed. The Kalman filter is restored by replacing the current state of the Kalman filter with the duplicate copy that was saved at step 314 and by replacing the current state of the associated co-variance matrix with the duplicate copy that was saved at step 314. This method, although more computationally expensive than the process depicted in FIG. 2 allows forgetting techniques to be used in the Kalman filter. Forgetting techniques, including adding process noise to the bias states, allow the Kalman filter to track changes in biases over time. These forgetting techniques can also cause the constraints to be forgotten and therefore necessitating the temporary application of the constraints. This helps to ensure that the constraints applied by the pseudo-measurements are not forgotten. In addition, the process depicted in FIG. 3 could be used to apply a variety of different models to the lookup table.

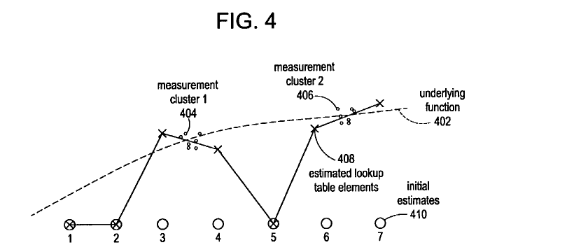

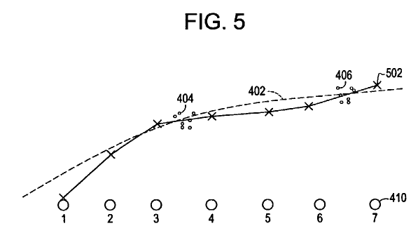

In an exemplary embodiment, the Kalman filter statistically fuses the pseudo-measurements with the measurement data that it receives from the sensors. If the measurement data provides no information about an element, then the a-priori information as specified in the initialization and constraints will be utilized. If, however, the measurement data provides very good information about the value of a table element, the measurement data will be utilized. In between, the Kalman filter weights the two sources of information by their respective uncertainties. For example, FIG. 4 shows typical results of a one dimensional lookup table without pseudo-measurement constraints and an underlying function 402 represented by the dashed line. The initial estimates 410 are represented by the circles at the bottom of FIG. 4 labeled one to seven. The measurement data from the sensors 404 406 includes two clusters of data. Based on the measurement data 404 406 and the initial estimates 410, the Kalman filter could estimate the lookup table elements 408 as represented by the x's in FIG. 4. This approach can provide discontinuity in the table, as depicted in FIG. 4, due to the lack of data between elements one through three and four through six. It may be known that these abrupt changes in table element values are not possible. If this is the case, pseudo-measurements can be applied to provide slope and curvature constraints in order to improve the fit of the state estimate, or table element values, to the underlying function 402. In an exemplary embodiment, the result of applying pseudo-measurements is depicted in FIG. 5. In FIG. 5, the estimated lookup table elements 502 more closely follow the underlying function 402. This technique of utilizing a Kalman filter including pseudo-measurements can be a convenient and computationally inexpensive approach to incorporating smoothness and other “soft” constraints on the lookup table curve fitting process. This technique can be used to prevent nonsensical fits, such as the one depicted in FIG. 4, to small, sparse or ill-conditioned data sets.

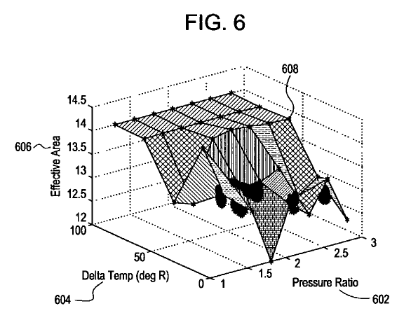

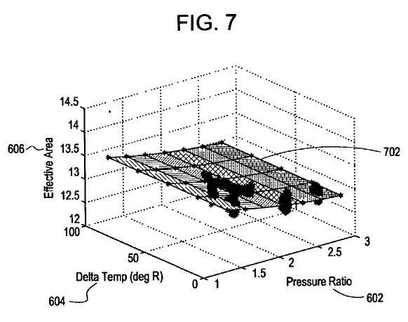

FIG. 6 shows typical of an exemplary two dimensional lookup table created by applying a Kalman filter and measurement data without pseudo-measurement constraints. The variables being measured include effective area 606, delta temperature 604 and pressure ratio 602. The resulting curve 608 includes jagged edges and widely varying results. FIG. 7, is an exemplary embodiment of the result of using the Kalman filter to estimate the lookup table depicted in FIG. 6, using measurement data and pseudo-measurement data (e.g., slope and curvature constraints). The curve representing the effective area 702 has been smoothed out as a result of applying the pseudo-measurement constraints.

An embodiment of the present invention provides an automatic method of building calibration lookup tables from sparse data. This can result in an efficient process for fitting high order polynomial curves to data that may describe complex shapes. This can also result in the ability to describe curves that fall in between orders. If the calibration data changes over time, the new values can be quickly and automatically calculated using an embodiment of the present invention. In addition, the forgetting technique described in reference to FIG. 3 can be utilized to adapt to changes over time while still imposing constraints on the resulting data. In an exemplary embodiment, where the present invention is utilized as part of a gas turbine steam leak detection application, the present invention can run in the background without requiring a team of experts to analyze the measurement data. This can result in catching errors and potential errors more quickly and at a cheaper cost.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for building a calibration lookup table, the method comprising:
initializing said lookup table including initializing a Kalman filter corresponding to said lookup table wherein said Kalman filter includes state estimates corresponding to table element values in said lookup table;
receiving sensor measurement data;
applying said sensor measurement data to said lookup table, wherein said applying said sensor measurement data to said lookup table includes updating said Kalman filter in response to said sensor measurement data;
receiving a constraint on said table element values;
receiving an output request;
storing a duplicate copy of said Kalman filter in response to said receiving an output request;
applying said constraint to said lookup table in response to said receiving an output request and to said storing, wherein said applying said constraint to said lookup table includes updating said Kalman filter in response to said constraint;
outputting a lookup table element in response to said applying said constraint and to said output request; and
replacing said Kalman filter with said duplicate copy of said Kalman filter in response to said outputting.

2. The method of claim 1 wherein said output request is received from a gas turbine engine diagnostics application.

3. The method of claim 1 wherein said output request is received from a gas turbine engine steam leak detection application.

4. The method of claim 1 wherein said output request includes a request for said lookup table and wherein said outputting includes outputting said lookup table including said table element values.

5. The method of claim 1 wherein said lookup table is one dimensional.

6. The method of claim 1 wherein said lookup table is two dimensional.

7. The method of claim 1 wherein said lookup table is three dimensional.

8. The method of claim 1 wherein said constraint imposes a limit on slope of said table element values.

9. The method of claim 1 wherein said constraint imposes a limit on curvature of said table element values.

10. The method of claim 1 wherein said sensor measurement data includes a delta temperature variable.

11. The method of claim 1 wherein said sensor measurement data includes a pressure ratio variable.

12. The method of claim 1 wherein said sensor measurement data includes an effective area of the flowpath variable.

13. A method for building a calibration lookup table, said method comprising:
initializing said lookup table including initializing a Kalman filter corresponding to said lookup table wherein said Kalman filter includes state estimates corresponding to table element values in said lookup table;
receiving a constraint on said table element values;
applying said constraint to said lookup table, wherein said applying said constraint to said lookup table includes updating said Kalman filter in response to said constraint;
receiving sensor measurement data; and
applying said sensor measurement data to said lookup table, wherein said applying said sensor measurement data to said lookup table includes updating said Kalman filter in response to said sensor measurement data.

14. The method of claim 13 further comprising:
receiving an output request; and
outputting a lookup table element in response to said output request.

15. The method of claim 14 wherein said output request is received from a gas turbine engine diagnostics application.

16. The method of claim 14 wherein said output request is received from a gas turbine engine steam leak detection application.

17. The method of claim 14 wherein said output request includes a request for said lookup table and wherein said outputting includes outputting said lookup table including said table element values.

18. The method of claim 13 wherein said constraint imposes a limit on slope of said table element values.

19. The method of claim 13 wherein said constraint imposes a limit on curvature of said table element values.

20. A system for building calibration lookup tables, the system comprising:
a sensor attached to a machine being diagnosed;
a host system in communication with said sensor, said host system including software to implement the method comprising:
initializing said lookup table including initializing a Kalman filter corresponding to said lookup table wherein said Kalman filter includes state estimates corresponding to table element values in said lookup table;
receiving sensor measurement data;
applying said sensor measurement data to said lookup table, wherein said applying said sensor measurement data to said lookup table includes updating said Kalman filter in response to said sensor measurement data;
receiving a constraint on said table element values;
receiving an output request;
storing a duplicate copy of said Kalman filter in response to said receiving an output request;
applying said constraint to said lookup table in response to said receiving an output request and to said storing, wherein said applying said constraint to said lookup table includes updating said Kalman filter in response to said constraint;
outputting a lookup table element in response to said applying said constraint and to said output request; and
replacing said Kalman filter with said duplicate copy of said Kalman filter in response to said outputting.

21. The system of claim 20 wherein said machine being diagnosed is a gas turbine engine.

22. The system of claim 20 further comprising a network, wherein said host system is in communication with said sensor via said network.

23. The system of claim 22 wherein said network is the Internet.

24. The system of claim 22 wherein said network is an intranet.

25. A system for building calibration lookup tables, the system comprising:
a sensor attached to a machine being diagnosed;
a host system in communication with said sensor, said host system including software to implement the method comprising:
initializing said lookup table including initializing a Kalman filter corresponding to said lookup table wherein said Kalman filter includes state estimates corresponding to table element values in said lookup table;
receiving a constraint on said table element values;
applying said constraint to said lookup table, wherein said applying said constraint to said lookup table includes updating said Kalman filter in response to said constraint;
receiving sensor measurement data; and
applying said sensor measurement data to said lookup table, wherein said applying said sensor measurement data to said lookup table includes updating said Kalman filter in response to said sensor measurement data.

26. The system of claim 25 wherein said machine being diagnosed is a gas turbine engine.

27. The system of claim 25 further comprising a network, wherein said host system is in communication with said sensor via said network.

28. The system of claim 27 wherein said network is the Internet.

29. The system of claim 27 wherein said network is an intranet.

30. A computer program product for building a calibration lookup table, the product comprising:
a storage medium readable by a processing circuit and storing instructions for execution by the processing circuit for performing a method comprising:
initializing said lookup table including initializing a Kalman filter corresponding to said lookup table wherein said Kalman filter includes state estimates corresponding to table element values in said lookup table;
receiving sensor measurement data;
applying said sensor measurement data to said lookup table, wherein said applying said sensor measurement data to said lookup table includes updating said Kalman filter in response to said sensor measurement data;
receiving a constraint on said table element values;
receiving an output request;
storing a duplicate copy of said Kalman filter in response to said receiving an output request;
applying said constraint to said lookup table in response to said receiving an output request and to said storing, wherein said applying said constraint to said lookup table includes updating said Kalman filter in response to said constraint;
outputting a lookup table element in response to said applying said constraint and to said output request; and
replacing said Kalman filter with said duplicate copy of said Kalman filter in response to said outputting.

31. A computer program product for building a calibration lookup table, the product comprising:
a storage medium readable by a processing circuit and storing instructions for execution by the processing circuit for performing a method comprising:
initializing said lookup table including initializing a Kalman filter corresponding to said lookup table wherein said Kalman filter includes state estimates corresponding to table element values in said lookup table;
receiving a constraint on said table element values;
applying said constraint to said lookup table, wherein said applying said constraint to said lookup table includes updating said Kalman filter in response to said constraint;
receiving sensor measurement data; and
applying said sensor measurement data to said lookup table, wherein said applying said sensor measurement data to said lookup table includes updating said Kalman filter in response to said sensor measurement data.
